(19) United States
(12) Patent Application Publication
(10) Pub. No.: US 2006/0250230 A1
(43) Pub. Date: Nov. 9, 2006

(54) Method for operating a monitoring and alarm device for parked vehicles and a monitoring and alarm device

(75) Inventors: Uwe Fischer, Frankfurt am Main (DE); Ralf Ludwig, Stuttgart (DE); Aurelien Mierswa, Stuttgart (DE); Alexander Trage, Nuernberg (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/408,007

(22) Filed: Apr. 21, 2006

(30) Foreign Application Priority Data
Apr. 21, 2005 (DE) 10 2005 018 487.1

(51) Int. Cl. G08B 23/00

(52) U.S. Cl. 340/500

(57) ABSTRACT

A method is provided for operating a monitoring and alarm device in a parked vehicle, in particular a lorry. The device includes sensor apparatus for determining a distance between the vehicle and an approaching object within an active zone, and reaction apparatus connected to a control unit and activated when the object approaches. The active zone is divided into at least a first, outer subzone and a second, inner subzone. The reaction apparatus is activated in terms of quantity, type, intensity and/or sequence in the first subzone in a stepped manner compared to activation of the reaction apparatus in terms of quantity, type, intensity and/or sequence in the second subzone.

### BACKGROUND AND SUMMARY OF THE INVENTION

The present invention relates to a method for operating a monitoring and alarm device for parked vehicles and to a monitoring and alarm device.

A wide range of alarm systems for protecting vehicles against theft are known. Such alarm systems have sensors for registering approaching persons, with the sensors being operatively connected to an electronic control system. When an approaching person is registered, the electronic control system activates a device with which sound signals and/or light signals can be output in order to deter the approaching person.

Published U.S. patent application Serial No. 2004/0263323 A1 proposes, for example, an anti-theft device for vehicles in which an approaching object is detected by distance sensors to determine whether the object is a suspicious person. In this context, in particular signals of a movement sensor are processed. In a suspicious situation, a warning signal, in particular a warning light, is activated. Although it is possible, with the proposed device, to determine, by reference to the type of movement and by reference to stored biometric data, whether the approaching object is a suspicious person, with this device it is not possible to rule out the possibility of a false alarm, in particular if, for example, an animal is located within the monitored area.

An object of the present invention is to provide an improved method for operating a monitoring and alarm device for parked vehicles and an improved monitoring and alarm device.

The object is achieved according to the invention by providing a method according to the invention for operating a monitoring and alarm device in a parked vehicle, in particular a lorry, which device comprises sensors for determining a distance between the vehicle and an approaching object within an active zone, and reaction apparatus connected to a control unit and activated when the object approaches. The active zone is divided into at least a first, outer subzone and a second, inner subzone, and the reaction means is activated in terms of quantity, type, intensity and/or sequence in the first subzone in a stepped fashion compared to activation of the reaction means in terms of quantity, type, intensity and/or sequence in the second subzone. The vehicle is located within the second, inner subzone.

Entry into the first subzone brings about a weaker reaction than entry into the second subzone which is located closer to the vehicle. It is advantageous that the monitoring and alarm device can react in a stepped manner. The driver is not warned unnecessarily if there is no specific risk. It is favorable here that the driver is not desensitized by unnecessary alarms. People who happen to be passing by are not unnecessarily startled when they pass the vehicle.

If, in one advantageous step, when the object enters the first subzone the reaction apparatus is essentially deployed to signal the detection of the entering of the approaching object to that object, a deterrent effect on an ill-intentioned person is obtained and a criminal act, for example a theft, is already prevented in advance. As a result, for example, external lighting of the vehicle can be switched on. The provision of separate information to the driver when the reaction apparatus is triggered can advantageously be omitted in this case. Nevertheless, the driver can feel assured since, if the situation escalates, there is a more severe reaction to the situation on the part of the monitoring and alarm device. The described function in the first subzone advantageously serves merely as a deterrent and for making it clear to the person, i.e., the approaching object, that the object's approach has been noticed.

When the object enters the second subzone, the reaction apparatus is preferably deployed so that the detection of the entering of said object is communicated to the wider surroundings of the vehicle. In addition, the vehicle driver can be provided with separate information about the entering of the object into the inner, second subzone, specifically both when the driver is located inside the vehicle as well as when the driver is located outside the vehicle. The reaction of the monitoring and alarm device and that of the reaction apparatus are amplified in this situation such that the approach of the object attracts attention because, for example, the lighting is amplified in such a manner that it is noticed from afar and/or there are clearly perceptible horn sounds which attract attention.

The reaction apparatus of the monitoring and alarm device is expediently activated as soon as an object enters the first, outer subzone. When the object approaches a boundary between the first subzone and the second subzone, a noise signal can be generated. This may be produced, for example, as a startling hissing sound from an air compressor in the vehicle. As a result, the approaching person is signalled that his continued approach is being registered. It is also contemplated provide for vehicle doors to be locked, as a result of which additional protection against break-in and theft can advantageously be provided.

Within at least one of the subzones, the reaction apparatus is preferably deployed in terms of quantity, type, intensity and/or sequence as a function of a duration of the entering of the object and/or of a distance of the object which has entered from the vehicle. As a result, when the distance between the approaching object and the vehicle drops below a defined minimum value and/or when a maximum permissible dwell time is exceeded, the intensity of a lighting system is increased continuously.

It is favorable if the intensity of a lighting system is changed so that it is possible to see well from inside the vehicle to the outside. The driver can thus observe the situation in the surroundings of the vehicle well from the driver's cab.

When a predefined permissible dwell time of the object in the first subzone is exceeded, a reaction of the reaction apparatus in terms of its quantity, type, intensity and/or sequence is preferably increased or amplified.

In one advantageous development of the invention, a sensitivity level of the active zone can be set as a function of a parking situation, and dimensioning of the subzones, the quantity, type, intensity and/or sequence of the reaction apparatus can be adapted as a function of the sensitivity level. In a car park which is heavily used, for example during the day at motorway service stations, a low sensitivity level can be set in order to avoid unnecessary false alarms being triggered. In a quiet, remote car park, setting a relatively high sensitivity level is preferable. When the sensitivity level is set to a high value, the second, inner subzone can be expanded. The first, outer subzone can advantageously be automatically adapted when the dimensioning of the second subzone changes.

The vehicle's own lighting apparatus and/or alarm apparatus can be activated as the reaction apparatus. For example, the front lights, rear lights, side light system, lighting devices between the driver's cab and the trailer of a preferred lorry, lighting devices between the trailers, lighting devices for illuminating the rear area of the vehicle and the like can be activated. As a result, there is advantageously no need for separate reaction apparatus or signal output devices.

The reaction apparatus is preferably activated with graduated intensity and/or in a graduated sequence, which makes it possible to determine which alarm level should be estimated. In this context, for example, a combination of dipped headlights, full beam headlights, flashing indicator lights, etc. can be activated in combination or individually depending on the degree of the escalation. When an approaching object enters the first subzone, the lighting apparatus can be activated at least in some cases with an intensity of approximately 30%. When the distance drops below a predefined minimum distance between the approaching object or the person and the vehicle the intensity of a lighting system can be increased continuously. The intensity of a lighting system can then be raised from 30% to 100% depending on the sensibility level which has been set for the active zone and/or the approach behavior of the object.

When the object enters the second subzone, the driver expediently receives separate audible, visual and/or haptic information, in particular via the vehicle key. When the object enters the second subzone, the reaction of the reaction apparatus can be amplified and as a result additional lighting devices and/or alarm devices can be activated. For example, an audible warning signal, such as an intermittent horn signal, can be output. At the same time, or as an alternative, the driver can receive a warning via a receiver in the vehicle key, for example by a light flashing on the vehicle key, by an audible signal being output and/or by a haptic signal such as a vibration alarm. The driver can thus be informed immediately about the escalation of the situation at the vehicle even when the driver is outside the vehicle, e.g., when the driver has stopped for coffee, a rest break or the like.

In order to avoid unnecessary false alarms, it is contemplated to advantageously differentiate whether the object is a person or an animal or an inanimate object by setting threshold values of the signal intensity which is measured by the sensor apparatus, was activation of the reaction apparatus being prevented when signal intensity drops below threshold values. A false alarm can be avoided if, for example, inanimate objects such as plants, paper and the like are blown or moved into the active zone owing, say, to a strong wind, or if an animal stays within the active zone for a relatively long time. A combination of distance sensors with infrared sensors proves particularly favorable here. Depending on the signal intensity to differentiation advantageously occurs between an approaching person, an approaching animal or an inanimate object.

In one advantageous embodiment of the present invention, in preset modes, the sensitivity level of the active zone and/or the reaction apparatus can be predefined in terms of quantity, type, intensity and/or sequence. In the method according to the invention, the various modes can be preset, but it is also contemplated to program further modes as a function of the situation. The modes can be activated individually, but a combination of a plurality of modes, for example a greeting mode in combination with a defense mode, is also utilizable.

Ill-intentioned persons are advantageously deterred with the different escalation of warning measures according to the present invention, while persons with positive intentions are welcomed. Since suitable illumination tends to deter ill-intentioned persons, the potential of light sources on and in the vehicle is thus already used in an expedient way to prevent a break-in to the vehicle before the deed begins. This advantageously provides a higher degree of security for the parked vehicle. Persons with positive intentions who, for example, pass by the vehicle may, on the other hand, feel that the lighting on the vehicle is pleasant and gives them an increased sense of security.

When an approaching authorized person is detected, the vehicle can be illuminated with low intensity in a preset greeting mode. This can be done, for example, as a result of the driver who carries a suitable transmitter and/or transponder on his person approaching his vehicle, or when the vehicle door is opened in the usual way. In the greeting mode, a dipped headlight function is preferably activated, as a result of which the driver can more easily find his way to the vehicle or more easily find a keyhole of a door lock, in particular in the dark. At the same time, brief flashing of the headlights can be activated and/or there can be chronologically staggered flashing of the side lights which are arranged one behind the other, which is effective in particular in the trailer of a lorry. Likewise, in a vehicle-leaving mode, the vehicle can acknowledge the departing driver with corresponding lighting, for example by lighting or flashing the side lights. In a permitted, preselected occupied mode, a selected region on the vehicle is illuminated.

When, in a visitor mode, the first subzone of the active zone is entered, an area around the vehicle can be illuminated, for example in a lorry by front lighting, lighting present between a driver's cab and a trailer and/or between two trailers. A region behind the vehicle can also be illuminated. The intensity of the lighting can also be increased the closer the visitor comes to the vehicle. In this way, the visitor is informed that the vehicle is being monitored. It is even contemplated to deter an ill-intentioned visitor from a possibly intended break-in if the vehicle is illuminated. A visitor with positive intentions may also feel that the lighting is pleasant if the area around the vehicle is illuminated so that he can pass by more easily.

In a permitted occupied mode, the monitoring and alarm device can be set in such a way that a selected area on the vehicle is illuminated. If the driver himself wishes, for example, to have a break but wishes to leave his vehicle, it is possible for his break to be made more pleasant in the permitted occupied mode, in particular at night, by virtue of the lighting. The lighting can be more dipped in the permitted occupied mode, and, for example, in the case of a lorry, for only an upper front light and/or an existing light between a driver's cab and/or between two trailers to be activated. If a defense mode is activated at the same time as the permitted occupied mode, the lighting apparatus can flash as soon as a further object or a further person enters the active zone. The driver is then informed that someone is approaching from behind. It is further contemplated that the vehicle doors can be locked automatically in this case.

In a defense mode, an alarm can be triggered by the monitoring and alarm device as soon as a non-authorized person tampers with the vehicle from the outside, for example “fiddles” or tampers with the door lock. In this case, a warning light can be activated. An audible warning signal can also be output simultaneously, for example an intermittent horn signal. At the same time, or as an alternative to this, the driver can be warned by way of a remote control system in the vehicle key, as has been described above.

There is preferably provision that when a panic button is activated, lighting apparatus in the vehicle cab and the lighting apparatus arranged on the outside are activated with such a ratio that there are good visibility conditions from the inside.

The monitoring and alarm device according to the invention in parked vehicles, in particular lorries, comprises sensor apparatus for determining a distance between the vehicle and an approaching object within an active zone and reaction apparatus which is connected to a control unit. The active zone is divided into at least a first, outer subzone and a second, inner subzone which is surrounded by the first subzone, the reaction apparatus is capable of being activated in terms of quantity, type, intensity and/or sequence in the first subzone in a stepped manner compared to activation of the reaction apparatus in terms of quantity, type, intensity and/or sequence in the second subzone.

The vehicle's own lighting apparatus and/or alarm apparatus are expediently provided as reaction apparatus. Sensor devices, in particular distance sensors, proximity sensors and/or movement sensors, preferably ultrasound sensors, are preferably embodied as apparatus for determining the distance between an approaching object and the vehicle. In one favorable embodiment, the sensor devices are arranged on front, lateral and/or front, rear lighting apparatus of the vehicle, must supply lines and/or signal lines of the monitoring and distance sensors being routed in cable ducts of the lighting apparatus. As a result, existing devices are already favorably used in the vehicle, which provides cost savings when installing the device according to the invention. The sensor devices can be connected to the control unit via a connecting station, the connecting station being preferably arranged in a vehicle cab, particularly preferably in the rear region of the vehicle cab, in the vehicle such as a lorry.

If supply lines and/or signal lines of the sensor devices are routed in cable ducts of the lighting apparatus, savings can be achieved in terms of the installation space when mounting the monitoring device and alarm device.

In one development of the invention, a panic button for the driver can be provided, particularly in the driver's cab, the activation of which causes the lighting apparatus in the driver's cab and the lighting apparatus arranged on the outside to be capable of being activated with such a ratio that there are good visibility conditions from the inside to the outside.

### BRIEF DESCRIPTION OF THE DRAWINGS

The foregoing objects an advantages will become more readily apparent from the following detailed description in conjunction with the following drawings which show an embodiment of the present invention and wherein:

FIG. 1 shows an embodiment of a monitoring and alarm device according to the invention in a lorry;

FIGS. 2a and 2b show a display scheme of selectable, preset modes with, respectively, an example of an individual representation of the set modes and a representation of all the possible combination possibilities of settable modes; and

FIG. 3 is a flow chart showing the method according to the present invention for operating a monitoring and alarm device.

### DETAILED DESCRIPTION OF THE DRAWINGS

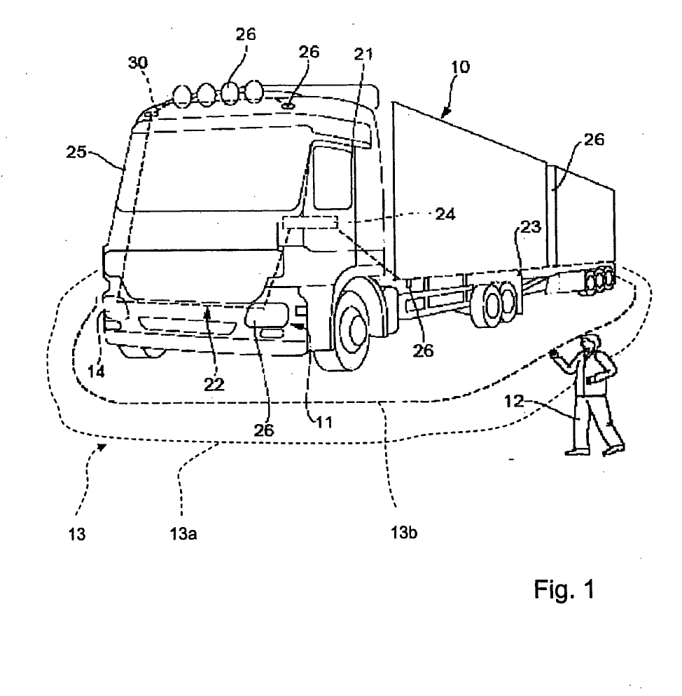

FIG. 1 shows an embodiment of a monitoring and alarm device 30 according to the invention in a parked vehicle, such as a lorry 10, with sensor devices which are embodied as distance sensors and have the purpose of determining a distance between the lorry 10 and an approaching object 12 within a monitored active zone 13 which surrounds the lorry 10. The monitoring and alarm device 30 is connected to and triggers reaction apparatus 14.

A control unit 22 is operatively connected to the sensor devices 11. In the active zone 13, a differentiation is made between a first, outer subzone 13a and a second, inner subzone 13b. Here, the first subzone 13a surrounds the second subzone 13b. Vehicle 10 is located within the second subzone 13b.

The monitoring and alarm device 30 is activated when an object 12 which is detected as being a person enters, the reaction apparatus 14 being triggered essentially with a deterrent function when a person 12 enters the first subzone 13a, the reaction apparatus 14 reacting weaker in terms of their quantity, type, intensity and/or sequence than when the second subzone 13b is entered.

When a person 12 approaches or enters the first subzone 13a of the active zone 13, the control unit 22 activates the reaction apparatus 14 which outputs, for example, audible and/or visual signals. The vehicle's own lighting devices 26 and/or alarm devices, for example the horn or compressed-air hissing, is activated as the reaction apparatus 14. When the approaching person 12 enters the first subzone 13a, the lighting devices 26 are activated at least partially with a relatively low intensity of approximately 30%.

In this context, the driver is not provided with separate information when the reaction apparatus 14 triggers in the first subzone 13a. When an object 12 enters the second, inner subzone 13b, the reaction apparatus 14 which essentially alarms the driver, is additionally or alternatively triggered so that the driver is reliably informed about the imminent risk, specifically irrespective of whether the driver has occupied the vehicle or has left it, for example at a motorway service station.

When the predefined dwell time of the object 12 in the first subzone 13a has been exceeded, a reaction by the reaction apparatus 14 is amplified by, for example, increasing the intensity of lighting of switched-on lighting devices or by connecting more lighting devices to the circuit. When the object 12 approaches a boundary between the first subzone 13a and the second subzone 13b, a noise signal is generated, for example hissing from an air compressor and/or it is possible to lock vehicle doors 21.

A sensitivity level of the active zone 13 can be set as a function of a parking situation. Dimensioning of the subzones 13a, 13b, and/or the severity of the reaction of the reaction apparatus 14 in terms of quantity, type, intensity and/or sequence can be correspondingly adapted. In the case of a sensitivity level which is set to a high value, for example for a car park which is used only infrequently, the second, inner subzone 13b is expanded and the first, outer subzone 13a is adapted automatically.

When the distance between the approaching object 12 and the vehicle 10 drops below a defined minimum distance, the intensity of a lighting system is increased continuously. In order to differentiate whether the object 12 is a person or an animal, threshold values of the signal intensity which is measured by the sensor apparatus 11 can be set, activation of the reaction apparatus 14 being prevented when said signal intensity drops below said threshold values. The sensor apparatus 11 can be embodied in some cases as ultrasound sensors and be arranged on lighting apparatus 26 of the vehicle 10 in the front region, in the lateral region and/or in the rear region of the vehicle 10. Supply lines and/or signal lines of the sensor apparatus 11 are preferably routed in already existing cable ducts 23 of the lighting apparatus 26. The sensor apparatus 11 are preferably connected via a connecting station 24 to the control unit 22, the connection station 24 being arranged in a vehicle cab 25 of the vehicle 10.

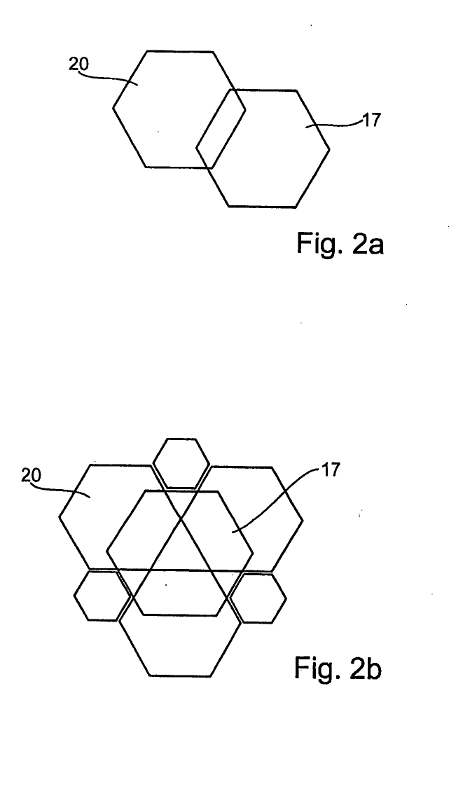

A display scheme of selectable, preset modes is shown in FIGS. 2a and 2b, each mode being assigned a different symbol. The symbols are represented, for example, on the display which is arranged in the driver's cab, the driver being able to select and check the setting of all the available modes. FIG. 2a shows, for example, how a selected combination of the monitoring mode 20 with visitor mode 17 is represented. Each of the modes 17, 20 is depicted in the form of an equally large regular hexagon, the hexagon preferably lighting up in different colors, for example red for the monitoring mode 20 and yellow for the visitor mode 17, and the hexagons overlapping partially.

In FIG. 2b, a multiplicity of selectable modes are represented by way of example. The individual displays overlap partially and are represented in different colors depending on the selection, and the colors light up depending on the setting. As a result, the driver can immediately recognize which mode is activated.

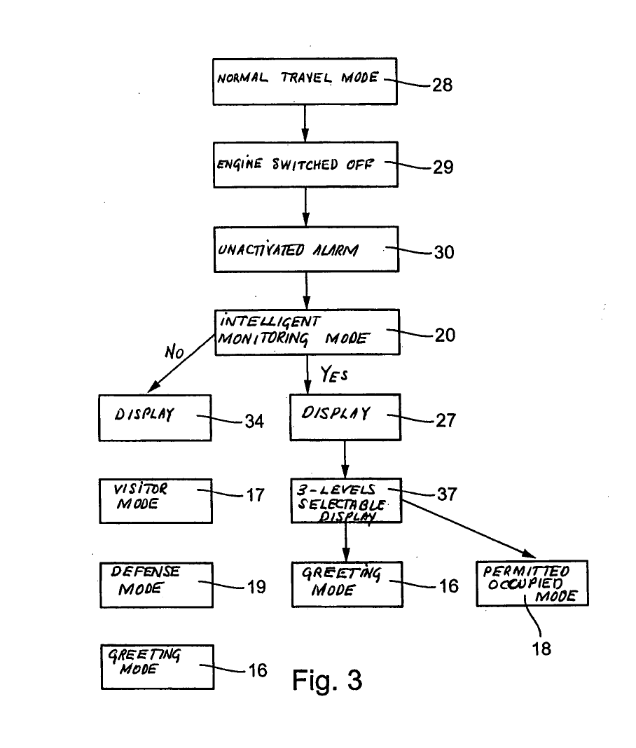

The FIG. 3 flowchart shows schematically a method according to the invention for operating a monitoring and alarm device 30. The method relates to a vehicle 10 which is preferably embodied as a lorry and is described in FIG. 1. The same reference symbols as in FIG. 1 are used for functionally identical elements. When a vehicle is in the normal travel mode 28, the monitoring and alarm device 30 is usually not activated. After the engine 29 has been switched off, the driver can decide whether or not he wishes to set an intelligent monitoring mode 20. When the monitoring mode 20 is activated, a display 27 lights, with the message “smart defense on”. The active zone 13 is divided according to the invention into two subzones 13a, 13b, as has been explained in the description in FIG. 1, the reaction apparatus 14 having the capability being set in terms of quantity, type, intensity and/or sequence in a graduated manner for each subzone 13a, 13b.

Depending on how frequently a car park in which the vehicle is parked is used, the driver can select a suitable sensitivity level of the active zone 13 in the monitoring mode 20.

In total, three sensitivity levels can be selected, which can be selected with a “three levels selectable” display 37 which lights up on the display. It is then possible to determine that a lighting apparatus 26 which is responsible for the external lighting is activated, as a result of which a permitted occupied mode 18 is set. The lighting apparatus 26 is caused to flash as soon as an object enters the active zone.

If the driver leaves the vehicle 10, a greeting mode 16 is activated by locking the vehicle doors. The driver can also be acknowledged as he leaves the vehicle 10. In the greeting mode 16, the monitoring and alarm system 30 is set so that an authorized person, that is to say the driver himself, is recognized. For this purpose, the authorized person carries a recognition device, for example a vehicle key with a transmitter or transponder or a separate transponder. In the greeting mode 16, in particular a dipped headlight function is activated as soon as the driver enters the active zone 13, or the vehicle doors 21 are opened by the driver.

If the driver decides not to activate the intelligent monitoring mode 20, a display 34 lights, with a corresponding message, for example “smart defense off”.

A visitor mode 17 can also be activated. After the visitor mode 17 has been activated, an object 12 which moves within the active zone 13 is detected, in which case an area all around the vehicle 10 is illuminated as soon as an object 12 enters the active zone 13. This is not intended to have a startling effect but instead to provide better lighting all around the vehicle 10 for the sake of better visibility. In a currently preferred vehicle 10 which is embodied as a lorry the visitor mode 17 can be deactivated, for example by removing a tachograph, that is to say when the driver therefore leaves or locks up the vehicle 10. The vehicle 10 can then remain unilluminated, for example in a fleet of lorries. After the vehicle door has been locked, a defense mode 19 is activated, and an alarm is triggered as soon as an unauthorized object 12 tampers with the vehicle 10 from the outside.

The intelligent monitoring mode 20 differentiates whether the person 12 enters the first subzone 13a, with deterrent reaction apparatus 14 being triggered, for example by lighting the vehicle's own lighting apparatus 26, or whether the subzone 13b is entered. Alarm-issuing reaction apparatus 14 are then additionally triggered, a warning being issued to the driver, for example by way of an audible and/or visual signal, or by emitting an audible, visual and/or haptic warning signal via a vehicle key. In addition to the monitoring mode 20, the greeting mode 16 whose sequence has been described above can be activated.

A panic button can be provided upon activation of which a lighting device in the vehicle cab 25 and the lighting apparatus 26 arranged on the outside are capable of being activated in a ratio such that there are good visibility conditions from the inside.

While we have shown and described one or more embodiments in accordance with the present invention, it is to be clearly understood that the present invention contemplate further changes and modifications without departing from its spirit. Therefore, we do not intend to be limited by the foregoing description but intend to cover all such changes and modifications falling witness the scope of the appended claims.

What is claimed is:

1. Method for monitoring and alarming a parked vehicle, comprising determining a distance between the vehicle and an approaching object within an active zone, dividing the active zone into at least a first, outer subzone and a second, inner subzone, and activating a reaction in terms of at least one of quantity, type, intensity and sequence in the first subzone in a stepped manner compared to a respective quantity, type, intensity and sequence in the second subzone.

2. Method according to claim 1, when the object enters the first subzone the reaction signals detection of the entering of the approaching object to said object.

3. Method according to claim 1, wherein, when the object enters the second subzone, the reaction communicates detection of the entering of said object to wider surroundings of the vehicle.

4. Method according to claim 2, when the object enters the first subzone the reaction signals detection of the entering of the approaching object to said object.

5. Method according to claim 3, wherein, a vehicle driver is provided with separate information about the entering of the object into the second subzone.

6. Method according to claim 1, wherein, the reaction is activated within at least one of the subzones as a function of at least one of a duration of the entering of the object and of a distance of the object which has entered from the vehicle.

7. Method according to claim 6, wherein, when the distance between the approaching object and the vehicle drops below a defined minimum value, intensity of a lighting system is increased continuously.

8. Method according to claim 7, wherein, the intensity is changed so as to be able to see from inside the vehicle to the outside.

9. Method according to claim 1, wherein, when a predefined permissible dwell time of the object in the first subzone is exceeded, the activated reaction is increased.

10. Method according to claim 1, wherein, when the object approaches a boundary between the outer subzone and the inner subzone, at least one of noise signal generation and vehicle door locking occur.

11. Method according to claim 1, wherein a sensitivity level of the active zone is set as a function of a parking situation, and at least one of dimensioning of the subzones and one or more of the quantity, type, intensity and sequence of the reaction is adapted as a function of the sensitivity level.

12. Method according to claim 11, wherein, when the dimensioning of the inner subzone changes, the outer subzone is automatically adapted.

13. Method according to claim 1, wherein at least one of the vehicle's own lighting system and alarm system is activated as the reaction.

14. Method according to claim 1, wherein, when the object enters the inner subzone, a driver receives two or more separate audible, visual and haptic types of information key.

15. Method according to claim 14, wherein the information is received via the vehicle key.

16. The method as claimed in claim 1, wherein a differentiation is made as to whether the object is a person, an animal or an inanimate object by setting threshold values of sensed signal intensity with activation of the reaction being prevented when said sensed signal intensity drops below said threshold values.

17. Method according to claim 1, wherein in each of preset modes, the sensitivity level of at least one of the active zone and the reaction is predefined in terms of at least one of quantity, type, intensity and sequence.

18. Method according to claim 17, wherein, when an approaching authorized person is detected, the vehicle is illuminated with low intensity in a preset greeting mode.

19. Method according to claim 17, wherein in a preset, permitted occupied mode, a selected area on the vehicle is illuminated.

20. Method according to claim 19, wherein, when a person approaches, lighting flashes in the selected area.

21. Method according to claim 17, wherein in a defense mode, an alarm is triggered immediately upon detecting a non-authorized person is tampering with the vehicle from outside.

22. Method according to claim 1, wherein, when a panic button is activated, lights in the vehicle cab and the lights arranged outside the vehicle are activated in a ratio such that good visibility conditions are established from the inside.

23. Monitoring and alarm device for use in a parked vehicle, comprising a control unit, sensor means for determining a distance between the vehicle and an approaching object within an active zone, and reaction means operatively connected to the control unit, wherein the active zone is divided into at least a first, outer subzone and a second, inner subzone which is surrounded by the first subzone, the reaction means being actuatable by the control unit in terms of at least one of quantity, type, intensity and sequence in the first subzone in a stepped manner compared to its actuation in respective terms in the second subzone.

24. Monitoring and alarm device according to claim 23, wherein at least one of a vehicle's own lighting system and alarm system constitute said reaction means.

25. Monitoring and alarm device according to claim 23, wherein at least one of supply lines and signal lines of the sensor means are routed in cable ducts of the lighting system.

26. Monitoring and alarm device according to claim 23, further comprising a panic button actionably arranged to cause a lighting system in a vehicle cabin and a lighting system arranged outside the vehicle to be activated in a ratio such that good visibility conditions are established inside the vehicle.
